(19) United States
(12) Patent Application Publication
(10) Pub. No.: US 2013/0229102 A1
(43) Pub. Date: Sep. 5, 2013

(54) SPARK PLUG

(71) Applicants: Jason J. Raasch, Cedarburg, WI (US); Robert Scott Ingham, Sylvania, OH (US)

(72) Inventors: Jason J. Raasch, Cedarburg, WI (US); Robert Scott Ingham, Sylvania, OH (US)

(73) Assignees: FEDERAL-MOGUL CORPORATION, Southfield, MI (US); BRIGGS & STRATTON CORPORATION

(21) Appl. No.: 13/411,081

(22) Filed: Mar. 2, 2012

(51) Int. Cl. H01T 13/20; H01T 13/16

(52) U.S. Cl. 313/11.5; 313/141

(57) ABSTRACT

A spark plug includes a terminal for receiving an electrical charge, a firing electrode on a firing end of the spark plug, and a conductor electrically coupling the terminal and firing electrode. The spark plug further includes a casing, an electrical insulator, and a ground electrode. The casing is at least partially formed from an electrically conductive material and is configured to be electrically coupled to a ground. The electrical insulator separates the conductor from the casing. The ground electrode is positioned proximate to the firing electrode, but separated from the firing electrode by a spark gap. The ground electrode includes an extension projecting from the casing such that the firing electrode is closer to the ground electrode than the firing electrode is to the casing. There is substantially no air gap between the interior of the casing and the electrical insulator from the firing end of the spark plug.

### CROSS-REFERENCE TO RELATED PATENT APPLICATIONS

This application claims the benefit of U.S. Provisional Application No. 61/275,042, filed Aug. 25, 2009, which is incorporated herein by reference in its entirety.

### BACKGROUND

The present invention relates generally to the field of spark plugs. More specifically, the present invention relates to spark plugs designed to reduce hydrocarbon emissions from internal combustion engines.

A spark plug is used with a gasoline-fueled engine to ignite an air and fuel mixture in a combustion chamber of the engine. The spark plug is coupled to the engine by screwing a threaded portion of the spark plug into a cylinder head of the engine such that a firing portion of the spark plug is within a combustion chamber. Other spark plugs may be clamped or otherwise fastened to the engine. An electrical charge is supplied by an ignition armature, ignition coil, magneto, or other source of electricity. Timing of the charge may coincide with piston strokes of a two- or four-stroke engine cycle. The electrical charge travels through an ignition lead wire of the engine to an ignition plug. The ignition plug connects to a terminal connection portion of the spark plug.

A high-voltage ignition pulse of electricity (i.e., electrical charge) enters a terminal electrode on the connection portion of the spark plug. The high-voltage pulse travels along a center wire of the spark plug. The wire runs through an axial bore formed within an electrical insulator of the spark plug. The electrical insulator may be formed from a ceramic material and may include ribs to increase the surface area of the spark plug, reducing the likelihood of charge traveling along the surface of the spark plug. The wire additionally passes through an annular shell of the spark plug, and couples to a firing electrode (i.e., central electrode, center electrode, etc.). The shell is typically formed from a conductive metal and may include the threaded portion. The wire is not electrically coupled to the shell, but is instead insulated from the shell via the electrical insulator, which extends between the wire and the shell.

The firing electrode extends into the combustion chamber of the engine. A tip of the firing electrode may be coated or formed from a precious metal, such as platinum, intended to reduce wear damage or corrosion. Proximate to the firing electrode, a ground electrode is connected to the shell of the spark plug. A spark arcs between the tip of the firing electrode and the ground electrode. The ground electrode is grounded by the shell coupled to the cylinder head, and the rest of the engine. The spark ignites fuel and air in the combustion chamber to drive the piston and power the engine.

An air gap is typically positioned between the electrical insulator and the shell on the firing end of the spark plug. Air has relatively poor thermal conductivity, and the air gap helps to thermally insulate the tip of the electrical insulator, allowing the tip of the electrical insulator to reach a temperature sufficient to prevent carbon deposits from forming on the surface of the tip of the electrical insulator, which may otherwise short the firing electrode with the shell. However, the gap may also provide a shelter for fuel and air to escape ignition during the combustion processes of the engine, allowing unburned fuel through the combustion chamber.

### SUMMARY

One embodiment of the invention relates to a spark plug, which includes a terminal for receiving an electrical charge, a firing electrode on a firing end of the spark plug, and a conductor electrically coupling the terminal and the firing electrode. The spark plug further includes a casing, an electrical insulator, and a ground electrode. The casing is at least partially formed from an electrically conductive material and is configured to be electrically coupled to a ground. The electrical insulator separates the conductor from the casing. The ground electrode is positioned proximate to the firing electrode, but is separated from the firing electrode to allow a spark to jump between the firing and ground electrodes during operation of the spark plug. The ground electrode includes an extension coupled to the casing and projecting from the casing such that the firing electrode is closer to the ground electrode than the firing electrode is to the casing. There is substantially no air gap between the interior of the casing and the electrical insulator from the firing end of the spark plug.

Another embodiment of the invention relates to a spark plug, which includes a terminal for receiving an electrical charge, a firing electrode on a firing end of the spark plug, and a conductor electrically coupling the terminal and the firing electrode. The spark plug further includes a casing, an electrical insulator, a ground electrode, and a thermal insulator. The casing is at least partially formed from an electrically conductive material and is configured to be electrically coupled to a ground. The electrical insulator separates the conductor from the casing. The ground electrode is positioned proximate to the firing electrode, but is separated from the firing electrode to allow a spark to jump between the firing and ground electrodes during operation of the spark plug. The thermal insulator extends between the casing and the electrical insulator on the firing end of the spark plug.

Yet another embodiment of the invention relates to a spark plug, which includes a terminal for receiving an electrical charge, a firing electrode on a firing end of the spark plug, and a conductor electrically coupling the terminal and the firing electrode. The spark plug further includes a casing, an electrical insulator, and a ground electrode. The casing is at least partially formed from an electrically conductive material and is configured to be electrically coupled to a ground. The electrical insulator separates the conductor from the casing. The ground electrode is positioned proximate to the firing electrode, but is separated from the firing electrode to allow a spark to jump between the firing and ground electrodes during operation of the spark plug. The electrical insulator adjoins the casing along the interior periphery of the casing at the firing end of the spark plug. A tip of the electrical insulator extends longitudinally from the casing on the firing end of the spark plug, such that the electrical insulator provides both a longitudinal separation and a latitudinal separation between the firing electrode and the casing on the firing end of the spark plug.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of a spark plug.

FIG. 2. is a perspective view of another spark plug.

FIG. 3. is a perspective view of a spark plug according to an exemplary embodiment of the invention.

FIG. 4. is a side view of a spark plug according to another exemplary embodiment of the invention.

FIG. 5. is a sectional view of a spark plug according to yet another exemplary embodiment of the invention.

FIG. 6 is a perspective view of a spark plug according to another embodiment of the invention.

FIG. 7 is a side view of the spark plug of FIG. 6.

FIG. 8 is a sectional view of the spark plug of FIG. 6, taken along line 8-8.

FIG. 9 is a sectional view of the spark plug of FIG. 8, taken along line 9-9.

FIG. 10 is a sectional view of a spark plug according to another exemplary embodiment of the invention.

FIG. 11 is an end view of the spark plug according to yet another exemplary embodiment of the invention.

FIG. 12 is a perspective view of a spark plug according to still another exemplary embodiment of the invention.

FIG. 13 is a sectional view of the spark plug of FIG. 12, taken along line 13-13.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

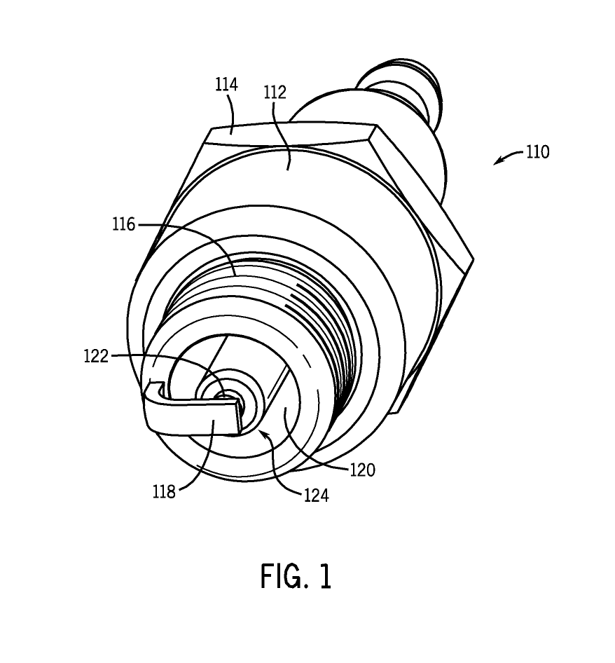

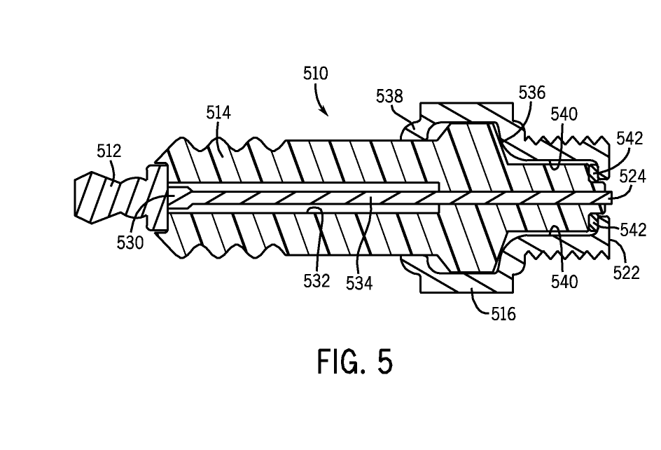

Referring to FIG. 1, a spark plug 110 includes an outer shell 112 having a hexagonal portion 114, a screwhead portion 116, and a hook electrode 118. The hexagonal portion 114 allows for a wrench to be used to turn the screwhead portion 116 into a cylinder head of a combustion engine. The hook electrode 118 serves as a ground electrode for the spark plug 110. The spark plug 110 further includes an electrical insulator 124 having an axial bore through which a center wire (see, e.g., carbon rod 534 as shown in FIG. 5) extends. The center wire terminates in a firing electrode 122. During operation of the spark plug 110, at particularly-timed intervals, sparks arc over a spark gap between the firing electrode 122 and the hook electrode 118.

Still referring to FIG. 1, the spark plug 110 further includes an air gap 120 (i.e., annular crevice) between the electrical insulator 124 and the shell 112. The air gap 120 thermally isolates the firing electrode 122 from the shell 112, allowing the firing electrode 122 and electrical insulator 124 to heat to a temperature hot enough to burn off oil or other deposits that might otherwise foul (or short) the spark plug 110, inhibiting the ability to form sparks. As mentioned, drawback of the air gap 120 is that unburned fuel and air may enter the air gap 120 and not be burned during the combustion stroke. Unburned fuel and air then exits the combustion chamber, resulting in increased hydrocarbon emissions.

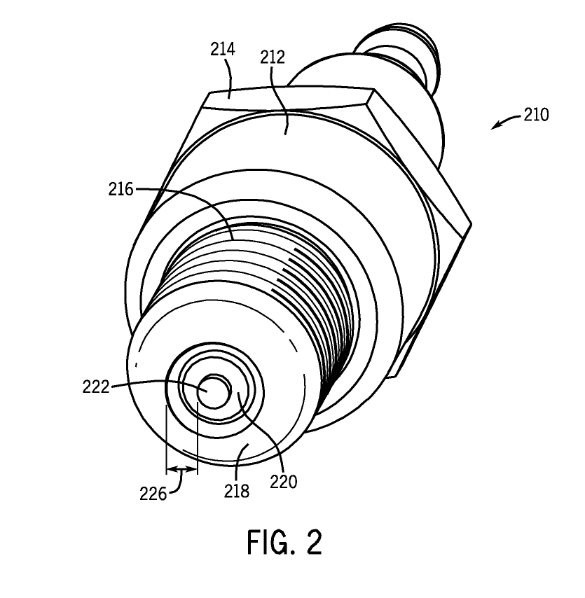

Referring to FIG. 2, a spark plug 210 includes an outer shell 212 having a hexagonal portion 214, a threaded portion 216, and a ground electrode 218, but no hook electrode (e.g., hook electrode 118 as shown in FIG. 1). The spark plug 210 further includes an electrical insulator 220 and a firing electrode 222. During operation of the spark plug 210, sparks arc laterally over a spark gap 226 between the firing electrode 222 and the ground electrode 218. The spark plug 210 may be used with a fast-running engine, such as an outboard engine for a motor boat, or a high-output engine (i.e., runs at high load).

The spark plug 210 does not include an air gap (e.g., air gap 120 as shown in FIG. 1) between the electrical insulator 220 and the ground electrode 218. During operation, conduction heat transfer occurs between the insulator 220 and the shell 212, which cools the insulator 220 more than the design of the spark plug 110. The cooler electrical insulator 220 may be unable to burn off oil or other deposits that may foul the firing electrode 222. The cooler firing electrode 222 or electrical insulator 220 of the spark plug 210 may not be a problem in hotter or faster-running engines, such as two-stroke engines and air-cooled small engines, because the firing electrode 222 or electrical insulator 220 may get hot enough to prevent fouling.

The spark gap 226 of the spark plug 210 is wider than the spark gap of the spark plug 110. As such, the wider spark gap 226 requires a greater electrical charge to initiate a longer arc between the firing electrode 222 and the ground electrode 218. For example, in a small engine with an ignition system not using a battery, the spark plug 210 may require an engine speed of approximately 200-300 revolutions per minute (rpm) to initiate a spark, while the spark plug 110 may generate sparks at an engine speed of approximately 150 rpm. As such, an engine with the spark plug 210 may be more difficult to start (e.g., with a recoil starter) than an engine with the spark plug 110.

Additionally, a spark of the spark plug 210 may occur further from the center of a corresponding combustion chamber than a spark of the spark plug 110, because the hook electrode 118 is directed into the combustion chamber, which orients the corresponding spark toward the center of the combustion chamber. Furthermore, a spark of the spark plug 110, with the hook electrode 118, is surrounded by fewer surfaces than a spark of the spark plug 210. The open space and closer-to-center location of a spark from the spark plug 110 may allow for a more efficient burn, as the flame propagates through the combustion chamber. A more efficient burn increases engine performance and may reduce hydrocarbon emissions.

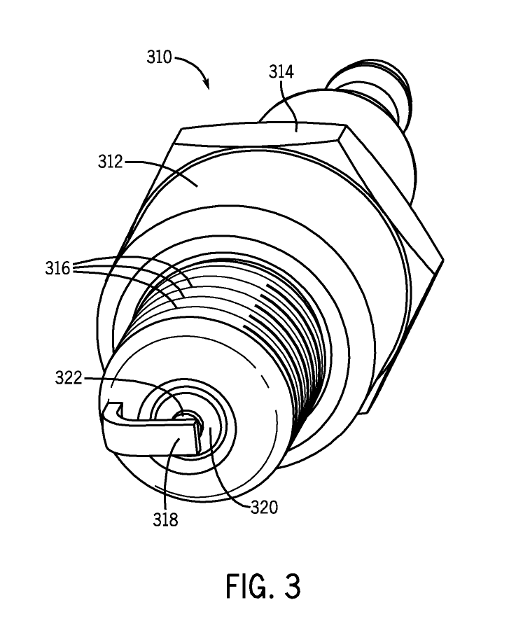

Referring to FIG. 3, a spark plug 310 includes an outer shell 312 having a hexagonal portion 314, a threaded portion 316, and a hook electrode 318 that is integrally connected to (e.g. welded to) the threaded portion 316 of the shell 312. The spark plug 310 further includes an electrical insulator 320 and a firing electrode 322, but does not include an air gap between the electrical insulator 320 and the firing electrode 322,210. During operation, sparks arc over a spark gap between the firing electrode 322 and the hook electrode 318. The spark gap of the spark plug 310 may be narrower than the spark gap 226 of the spark plug 210, which, for an engine with an ignition system not using a battery, allows for a slower engine speed (rpm) to produce a spark, improving start-ability of the engine. Additionally, the lack of an air gap reduces hydrocarbon emissions of an engine using the spark plug 310 by preventing the opportunity for unburned fuel and air to be caught in the air gap (e.g., air gap 120 as shown in FIG. 1). However, similar to the spark plug 210, the spark plug 310 may have a lower-temperature firing electrode 322, which may be susceptible to fouling. Increased chances of misfiring due to spark plug 310 fouling may increase hydrocarbon emissions.

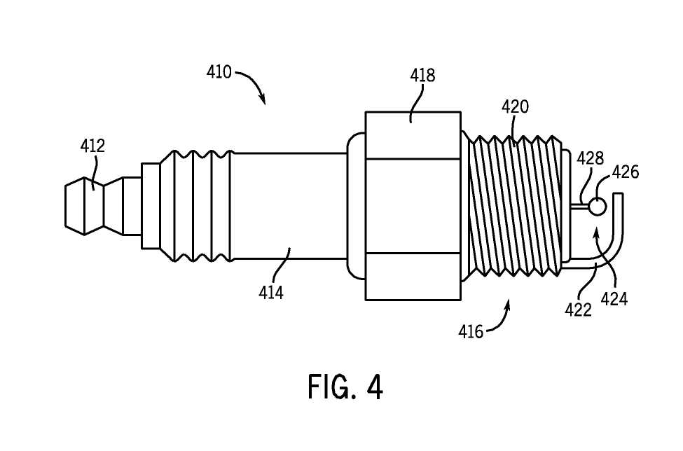

Referring to FIG. 4, a spark plug 410 includes a terminal connection portion 412 having a terminal electrode, a ceramic electrical insulator 414 having an axial bore through which extends a center wire. The electrical insulator 414 is fastened to a shell 416 (i.e., jacket, casing, etc.), which includes a hexagonal surface 418, a screwhead 420, and a hook electrode 422. Extending from within the shell 416, a firing electrode 424 includes a bulbous tip 426 (e.g., terminus, end) and a narrower rod 428 (e.g., neck) that connects to the center wire or carbon rod.

Similar to the spark plugs 210, 310, the spark plug 410 includes no air gap (e.g., air gap 120 as shown in FIG. 1) between the electrical insulator 414 and the firing electrode 424. Additionally the firing electrode 424 is designed to reduce heat transfer away from the tip 426. Increased surface area of the tip 426 is intended to increase the rate of heat flux into the tip 426, while the narrow cross-section of the rod 428 reduces the ability of the heat to transfer away from the tip 426. The hotter tip 426 temperature may be able to reduce the chances of spark plug 410 fouling by increasing the ability of the spark plug 410 to burn off oil or other deposits on the tip 426, when compared to the spark plugs 210, 310. In other embodiments, the tip of the spark plug 410 may be shapes other than a bulb, such as diamond-shaped, box-shaped, etc., having an increased cross-sectional area relative to the rod 428.

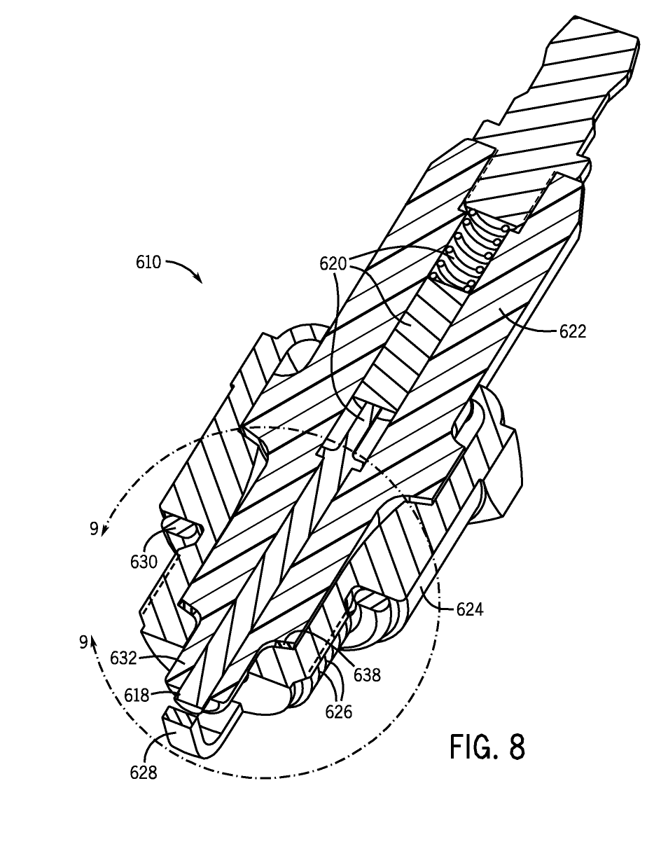

Referring to FIG. 5, a spark plug 510 includes a terminal connection portion 512 having a terminal electrode 530, a porcelain electrical insulator 514 having an axial bore 532 through which extends a carbon rod 534 with increased electrical resistance to reduce RF interference (see also conductor 620 in FIG. 8, which includes a carbon pellet). The electrical insulator 514 extends within a shell 516, which includes shoulders 536, 538 to hold the electrical insulator 514. The rod 534 terminates in a firing electrode 524 from which sparks arc to a ground electrode 522 coupled to the shell 516. In other embodiments, capacitive or inductive elements are used in place of a resistive element.

The spark plug 510 further includes an annular air gap 540 that is sealed off from the combustion chamber by a thermally-insulating washer 542 positioned between the porcelain electrical insulator 514 and the shell 516. The washer 542 is designed to compliment the air gap 540, reducing heat transfer between the porcelain electrical insulator 514 and the shell 516. As such, the firing electrode 524 and porcelain electrical insulator 514 becomes hot enough to reduce the chance of spark plug 510 fouling. The thermally-insulating washer 542 may be formed from a commercially-available thermally-insulating material having a low thermal conductivity (e.g., cement, fiberglass).

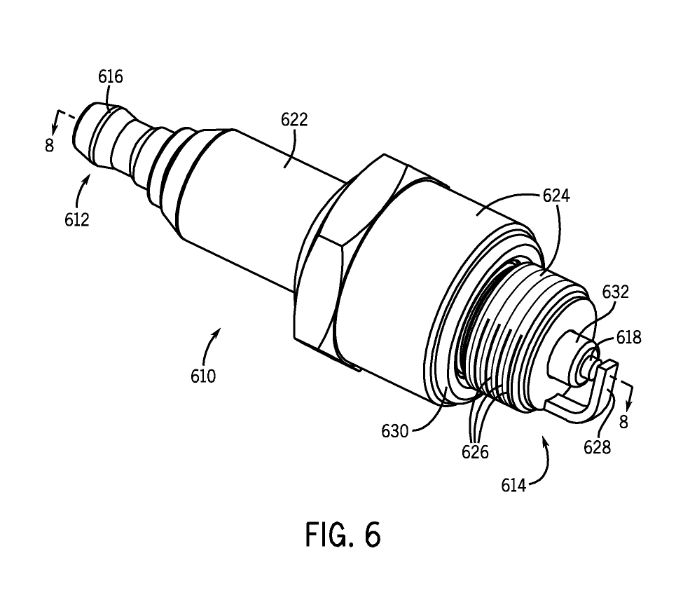

Referring to FIG. 6, a spark plug 610 includes a terminal end 612 and a firing end 614. The terminal end 612 includes a terminal 616 configured to receive an electrical charge, such as from an ignition armature of an engine. On the firing end 614, the spark plug 610 includes a firing electrode 618 (e.g., positive electrode, cathode, central electrode) in electrical communication with the terminal 616 by way of a conductor 620 (FIG. 8) extending through an insulator 622.

The spark plug 610 further includes a casing 624 (e.g., shell) at least partially formed from an electrically conductive material allowing the casing to be electrically coupled to a ground, such as a cylinder head of the engine. A ground electrode 628 (e.g., negative electrode, anode, side electrode) is coupled to the casing 624. In some embodiments, the casing 624 includes threading 626 that is designed to fasten the spark plug 610 with the cylinder head of the engine, so that the firing end 614 is in communication with fuel in the combustion chamber. According to a preferred embodiment, there is substantially no air gap between the casing 624 and the insulator 622 on the firing end 614 of the spark plug 610.

In some embodiments, the spark plug 610 includes a washer 630 configured for sealing and securing the casing 624 to the cylinder head of the engine. In some such embodiments, the washer 630 is a trifold or other form of compressible washer. Compression of the washer 630 helps to control the torque between the spark plug 610 and the cylinder head. In some embodiments, the washer 630 may be formed from a thermally-insulating material.

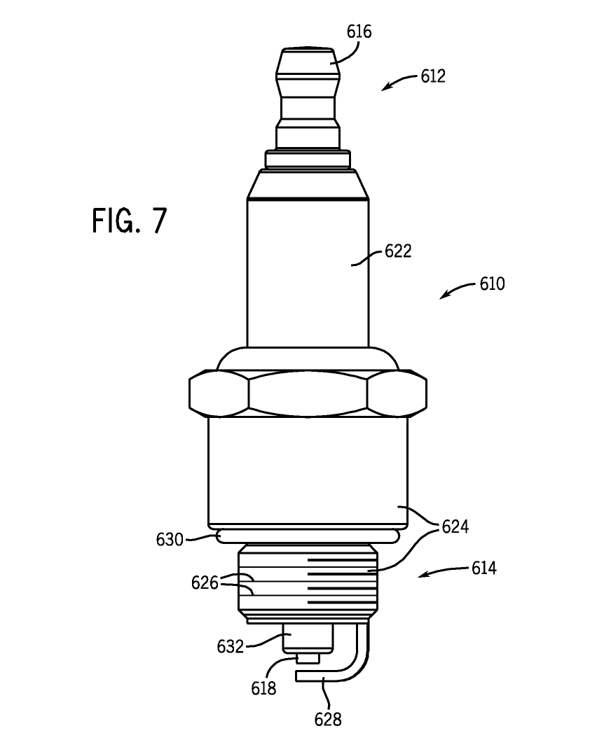

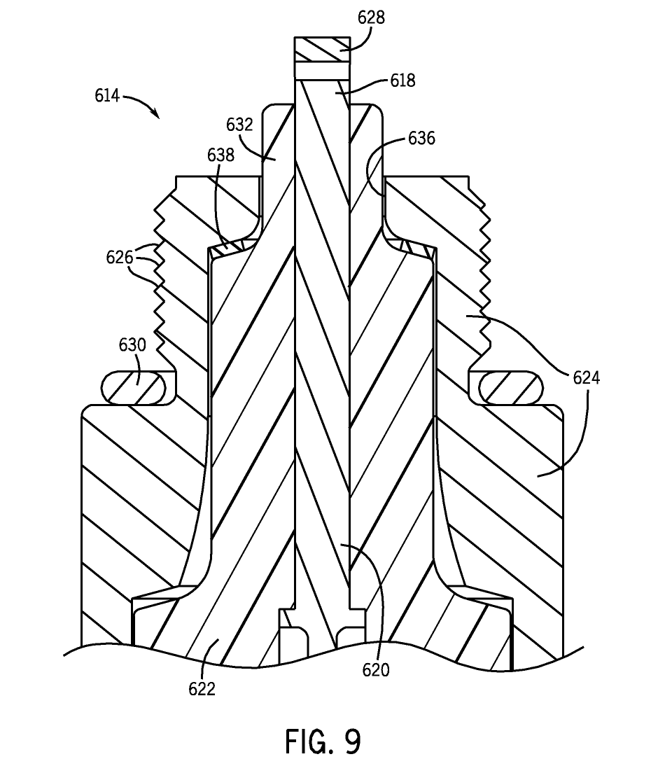

Referring to FIG. 7, the ground electrode 628 is coupled to and projects from a portion of the casing 624, toward the firing electrode 618 and locating the ground electrode 628 proximate to the firing electrode 618. However, the spark plug 610 includes a narrow space longitudinally positioned between the firing and ground electrodes 618, 628 (see also FIG. 9 with space shown as a rectangle between the electrodes 618, 628), which in some embodiments may be less than about an eighth of an inch. During operation of the spark plug 610, sparks jump between the firing and ground electrodes 618, 628. In some embodiments, the ground electrode 628 is hook shaped and extends in front of the firing electrode 618 such that a spark jumps longitudinally between the firing and ground electrodes 618, 628.

According to an exemplary embodiment, a tip 632 of the electrical insulator 622 extends longitudinally beyond the casing 624 on the firing end 614 of the spark plug 610 by a distance (see also FIG. 9 showing the distance that the insulator 632 extends beyond the casing 624 in the longitudinal direction). As such, the firing electrode 618 is separated from the casing 624 longitudinally as well as latitudinally, helping to prevent shorting by providing a longer surface path between the firing electrode 618 and the casing 624. Additionally, extending the tip 632 of the electrical insulator 622 beyond the casing 624 increases the surface area of the tip 632 exposed to heat from the combustion chamber, increasing heat flux into the electrical insulator 622, and in turn helping to prevent and/or remove carbon deposits from the tip 632 of the electrical insulator 622. In some embodiments, the tip 632 extends more than a sixteenth of an inch beyond the casing 624 on the firing end 614 of the spark plug 610, such as about an eighth of an inch.

Referring to FIG. 8-9, according to an exemplary embodiment, the electrical insulator 622 is formed from ceramic material (e.g., porcelain) and the casing 624 is formed from metal (e.g., ferric metal). In some embodiments, the electrical insulator 622 extends through and electrically separates the conductor 620 from the casing 624. In some embodiments, seals 638 (e.g., washer, gasket, adhesives) are used between the electrical insulator 622 and the casing 624 to prevent pressurized gases in the combustion chamber from passing through the spark plug 610 to escape the combustion chamber.

Referring specifically to FIG. 9, the electrical insulator 622 adjoins the interior periphery 636 of the casing 624 on the firing end 614 of the spark plug 610, preventing fuel-carrying air (e.g., fuel and air mixture, fuel-enriched air, fuel vapor) in the combustion chamber from being shielded from ignition between the electrical insulator 622 and the casing 624. In some embodiments, the electrical insulator 622 fully contacts the interior periphery 636 of the casing 624. In other embodiments, the electrical insulator 622 is slightly separated from the casing 624 by an additional thermal insulator, such as a thermally-insulating washer, gasket, coating, etc. (see, e.g., thermally-insulating washer as shown in FIG. 5).

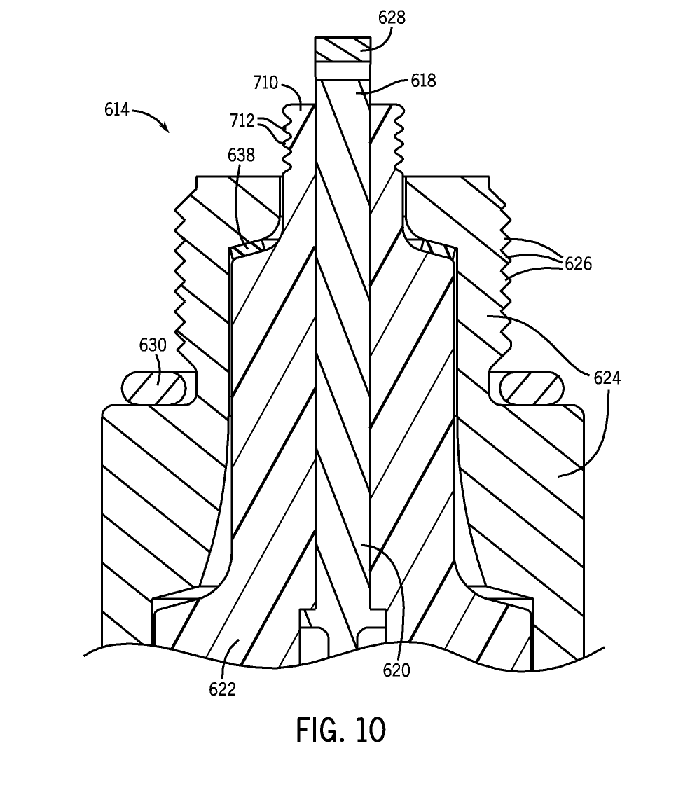

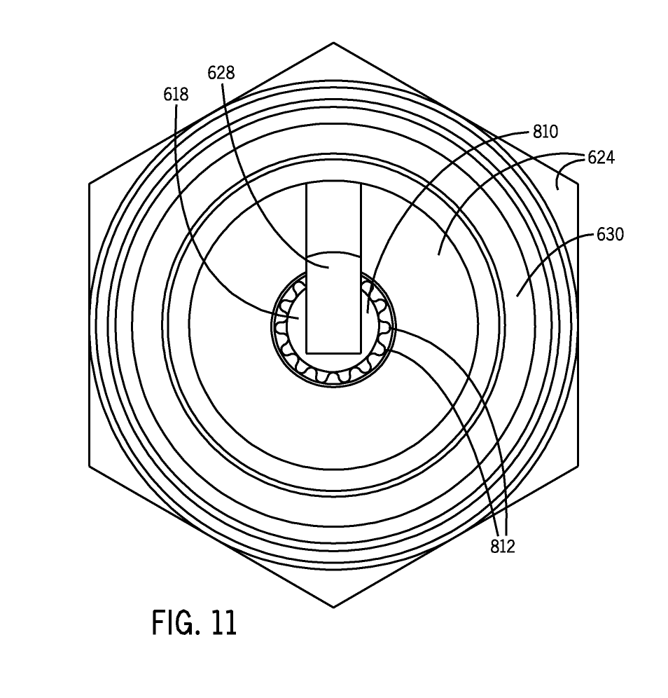

Referring to FIGS. 10-11, in some exemplary embodiments a tip 710, 810 of the electrical insulator 622 includes ridges 712 (FIG. 10), waves 812 (FIG. 11), spikes, spines, and/or other contours (e.g., surface curvature) designed to increase the exterior surface area of the tip 710, 810. Increased surface area exposed to the heat of the combustion chamber increases heat flux into the tip 710, 810, helping to burn off and/or prevent carbon deposits on the exterior surface of the tip 710, 810 of the electrical insulator 622. Prevention and/or removal of the carbon deposits helps to prevent shorting of the spark plug 610, and in turn, to prevent fouling the spark plug 610, wasting fuel, and production of hydrocarbon emissions.

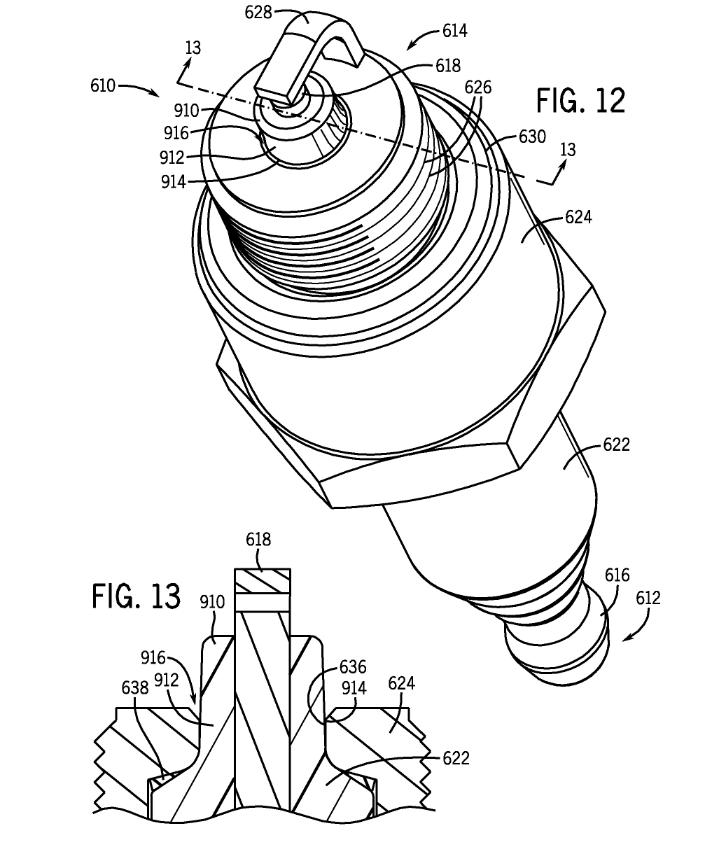

Referring to FIGS. 12-13, manufacturing the spark plug 610 with narrow tolerances between the electrical insulator 622 and casing 624 on the firing end 614 may be inefficient with regard to time, effort, or cost. Instead, providing a curvature 912 (e.g., widening curvature, conical curvature) to the tip 910 of the electrical insulator 622 and/or a curvature 914 (e.g., bevel) to the interior periphery 636 of the casing 624 allows for a broader tolerances when manufacturing the spark plug 610, while still substantially providing no gap for fuel-carrying air to avoid combustion between the electrical insulator 622 and the casing 624. Instead, only a small groove 916 is formed, which is believed to effectively provide the same improved emissions benefit provided by the spark plug 610 with narrower tolerances (see, e.g., FIG. 6).

In contemplated embodiments, a spark plug includes an electrical insulator formed from a material that is also thermally insulating (e.g., cement including fine-grain quartz), which is intended to keep a higher surface temperature by retaining heat while also electrically separating the conductor and the casing. In such embodiments, the electrical insulator (and also thermal insulator) adjoins the casing to prevent fuel-carrying air from avoiding ignition. The electrical insulator may extend longitudinally beyond the casing to improve heat retention of the tip of the electrical insulator, and to improve electrical isolation of the firing electrode from the casing. In such contemplated embodiments, the spark plug may also include a hook-shaped ground electrode.

In other contemplated embodiments, a ground electrode may not extend toward the firing electrode, but may project from the casing as a straight rod. In such contemplated embodiments, the ground electrode may extend substantially in parallel with the firing electrode, such that the firing electrode is closer to the ground electrode than the firing electrode is to the casing. A spark would jump horizontally between the firing electrode and such a ground electrode. Use of a straight ground electrode may expose the tip of the insulator to a greater amount of heat from the combustion chamber than use of a hook-shaped electrode, which may partially shield the tip of the insulator.

The construction and arrangements of the spark plug, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A spark plug, comprising:
a terminal for receiving an electrical charge;
a firing electrode on a firing end of the spark plug;
a conductor electrically coupling the terminal and the firing electrode;
a casing at least partially formed from an electrically conductive material and configured to be electrically coupled to a ground;
an electrical insulator separating the conductor from the casing; and
a ground electrode positioned proximate to the firing electrode, but separated from the firing electrode to allow a spark to jump between the firing and ground electrodes during operation of the spark plug, wherein the ground electrode includes an extension coupled to the casing and projecting from the casing such that the firing electrode is closer to the ground electrode than the firing electrode is to the casing, and
wherein there is substantially no air gap between the interior of the casing and the electrical insulator from the firing end of the spark plug.

2. The spark plug of claim 1, wherein the electrical insulator adjoins the casing along the interior periphery of the casing on the firing end of the spark plug.

3. The spark plug of claim 2, wherein a tip of the electrical insulator extends longitudinally from the casing on the firing end of the spark plug, such that the electrical insulator provides both a longitudinal separation and a latitudinal separation between the firing electrode and the casing on the firing end of the spark plug.

4. The spark plug of claim 3, wherein the tip of the electrical insulator extends longitudinally from the casing on the firing end of the spark plug by a distance of at least a sixteenth of an inch.

5. The spark plug of claim 4, wherein the tip of the electrical insulator extends longitudinally from the casing on the firing end of the spark plug by a distance of about an eighth of an inch.

6. The spark plug of claim 1, further comprising:
a thermal insulator extending between the casing and the electrical insulator on the firing end of the spark plug.

7. The spark plug of claim 1, wherein the firing electrode includes a neck and a terminus, wherein the neck extends longitudinally beyond the electrical insulator and the terminus extends from the neck, and wherein the terminus of the firing electrode has a wider latitudinal cross-section than the neck.

8. The spark plug of claim 7, wherein the terminus of the firing electrode is bulbous.

9. The spark plug of claim 1, wherein the casing includes a threaded exterior for fastening the spark plug to a cylinder head, wherein the electrically conductive material of the casing is metal, wherein the extension of the ground electrode comprises a metal hook, wherein the electrical insulator is ceramic, and wherein the firing and ground electrodes are separated by less than an eighth of an inch.

10. A spark plug, comprising:
a terminal for receiving an electrical charge;
a firing electrode on a firing end of the spark plug;
a conductor electrically coupling the terminal and the firing electrode;
a casing at least partially formed from an electrically conductive material and configured to be electrically coupled to a ground;
an electrical insulator separating the conductor from the casing;
a ground electrode positioned proximate to the firing electrode, but separated from the firing electrode to allow a spark to jump between the firing and ground electrodes during operation of the spark plug; and
a thermal insulator extending between the casing and the electrical insulator on the firing end of the spark plug.

11. The spark plug of claim 10, wherein the thermal insulator contacts the casing along the interior periphery of the casing at the firing end of the spark plug.

12. The spark plug of claim 11, wherein the thermal insulator blocks access of fuel-carrying air to flow between the interior of the casing and the electrical insulator from the firing end of the spark plug.

13. The spark plug of claim 12, wherein the thermal insulator comprises fiberglass.

14. The spark plug of claim 12, wherein a tip of the electrical insulator extends longitudinally from the casing on the firing end of the spark plug, such that the electrical insulator provides both a longitudinal separation and a latitudinal separation between the firing electrode and the casing on the firing end of the spark plug.

15. The spark plug of claim 12, wherein the ground electrode includes an extension coupled to the casing and projecting from the casing such that the firing electrode is closer to the ground electrode than the firing electrode is to the casing.

16. A spark plug, comprising:
a terminal for receiving an electrical charge;
a firing electrode on a firing end of the spark plug;
a conductor electrically coupling the terminal and the firing electrode;
a casing at least partially formed from an electrically conductive material and configured to be electrically coupled to a ground;
an electrical insulator separating the conductor from the casing; and
a ground electrode positioned proximate to the firing electrode, but separated from the firing electrode to allow a spark to jump between the firing and ground electrodes during operation of the spark plug;
wherein the electrical insulator adjoins the casing along the interior periphery of the casing at the firing end of the spark plug, and
wherein a tip of the electrical insulator extends longitudinally from the casing on the firing end of the spark plug, such that the electrical insulator provides both a longitudinal separation and a latitudinal separation between the firing electrode and the casing on the firing end of the spark plug.

17. The spark plug of claim 16, wherein the tip of the electrical insulator extends longitudinally from the casing on the firing end of the spark plug by a distance of at least a sixteenth of an inch.

18. The spark plug of claim 17, wherein the tip of the electrical insulator extends longitudinally from the casing on the firing end of the spark plug by a distance of about an eighth of an inch.

19. The spark plug of claim 17, wherein the exterior surface of the tip of the electrical insulator is contoured to increase the surface area of the tip.

20. The spark plug of claim 19, wherein the ground electrode includes an extension coupled to the casing and projecting from the casing such that the firing electrode is closer to the ground electrode than the firing electrode is to the casing.
